(19) United States
(12) Patent Application Publication
(10) Pub. No.: US 2004/0208603 A1
(43) Pub. Date: Oct. 21, 2004

(54) Mobile infrared communication system

(76) Inventors: Steve D Hekkel, Hammond, IN (US); Barney S Smith, Whiting, IN (US)

Correspondence Address: Steven D. Hekkel, Dyna-Tak, Inc., 810 - 169th Place, Hammond, IN, 46324, US

(21) Appl. No.: 10/138,965

(22) Filed: May 3, 2002

(51) Int. Cl. H04B 10/24; H04B 10/00

(52) U.S. Cl. 398/140

(57) ABSTRACT

An IR FM communication system for full-duplex communication between mobile IR devices such as headsets or a headset and a module that is connectable to an aircraft or other vehicle communication system. Each mobile IR device includes a transmitter circuit and a receiver circuit. The transmitter produces an IR emission beam extending approximately 360° in azimuth and at least 15° in elevation. The receiver has a detection envelope extending approximately 360° in azimuth and at least 45° in elevation.

### BACKGROUND OF THE INVENTION

1. Field of the Invention

The present invention generally relates to optical communication systems and more particularly to mobile full-duplex infrared (IR) communication systems. Such systems have a variety of applications, especially in environments where it is desirable to use wireless communications that do not rely on the radio spectrum for transmission and reception. One such application is for aircraft cockpit communication and ground-crew servicing communication.

2. Review of the Prior Art

Optical communication systems are especially useful for communications in environments where it is desirable to avoid using the radio spectrum. While many communication devices and systems utilizing optical transmission and reception are known in the art, a number of limitations restrict their usefulness and application.

Most systems providing a mobile unit such as a headset require a fixed device often referred to as a base station. In addition, most systems are not operable in direct sunlight and are not adaptable for use in a vehicle cabin such as an aircraft cockpit. Examples of such prior systems are Menadier et al., U.S. Pat. No. 5,027,433 and Wilton et al., U.S. Pat. No. 6,130,953. Both Menadier et al. and Wilton et al. disclose an IR headset for communicating in a fixed area with an IR base station device.

Other systems provide IR communications between two mobile devices without requiring a fixed base station; however, such systems have a number of limitations that restrict their application and usefulness. For example, the devices of Jensen et al., U.S. Pat. No. 3,277,303 and Owen, U.S. Pat. No. 5,648,862 both disclose IR communication devices that communicate directly with another mobile device. The device disclosed by Owen is for use with a night vision system and is both large and cumbersome. The device disclosed by Jensen is incorporated into the optics of binoculars. Thus, both devices require very accurate pointing as they have narrow transmission beams and narrow detection envelopes. The devices also restrict the user's vision and freedom of movement while in use.

What is needed is a mobile IR communication system that supports full-duplex communication between at least two individuals or between an individual and a vehicle communication system. The system should not rely on a fixed base station or IR repeaters, but directly communicate between two mobile devices that do not restrict the user's vision or freedom of movement.

In addition, the system should function in direct sunlight and have a wide transmission beam and a wide detection envelope so that accurate pointing is not required for communication.

### SUMMARY OF THE INVENTION

The present invention provides a mobile full-duplex IR communication system for communicating between at least two mobile devices. Embodiments include a system for direct communication between two or more headsets and a system for communicating between a headset and an IR module that is electrically connected to an aircraft communication system.

The difficulties with prior IR communication devices are overcome by various aspects of the current invention. The communication system of the current invention includes multiple mobile IR devices each having a transmitter and receiver means. Preferred embodiments include a headset having a microphone and earphone and an IR module that is mountable in the cabin of a vehicle or aircraft and electrically connects to the vehicle or aircraft communication system. The inventive IR devices overcome one limitation of the prior art in that they each have a large IR transmission beam and detection envelope. A plurality of series coupled IR light emitting diodes (LEDs) are networked together in parallel circuits and mounted in a pattern that produces a transmission beam of approximately 360° in azimuth and at least 15° in elevation. In addition, a plurality of positive intrinsic negative devices (PINs) are electrically connected in a parallel network and mounted in a pattern that forms a detection envelope of approximately 360° in azimuth and at least 45° in elevation. The LED and PIN networks can be mounted on the earphone housings of the IR headset or on the IR module that electrically connects to a vehicle communication system. This arrangement expands the transmission beam and detection envelope in order to eliminate the accurate and cumbersome pointing required by prior devices.

Each IR device of the current invention includes an IR transmitter means and an IR receiver means capable of full-duplex IR communication with another mobile IR device in accordance with the current invention. Thus, no fixed base station, repeater or other similar device is required. In one embodiment of the current invention, the communication system includes a headset having a microphone and earphones, and an IR transmitter and receiver for communicating with a mobile IR module, that is electrically connectable to an aircraft or other vehicle communication system. In another embodiment of the current invention, the IR communication system includes at least two headsets each having a microphone, earphones, and an IR transmitter and receiver. Each IR headset is capable of direct communication with the other headset(s) in the system.

In another aspect of the invention, the IR communication system is operable in direct sunlight and supports wireless communication without reliance on the radio spectrum. The IR transmitters of each device can use LEDs operating at a wavelength of 940 nm or IR lasers. To achieve high-quality audio reproduction of a transmitted signal in various environments and at various ranges, the system uses FM at a carrier frequency in the range of 50-250 KHz. In addition, the IR transmitters and receivers utilize crystal-stabilized frequency synthesizers and pre-emphasis and de-emphasis circuits. The receiver may also further include an IF amplifier. Each IR device provides field selection of a different carrier frequency for the receiver and the transmitter so that full-duplex communication can be supported. Furthermore, the IR transmitters include a threshold adjustable voice-activated switch.

The invention further provides a method of IR communication between at least two users each equipped with an IR headset, and a method of IR communication between an IR headset and an aircraft or other vehicle communication system.

The present invention is advantageous in that it overcomes limitations of prior systems and the inventive devices can be constructed predominantly of standard components that provide a lightweight, mobile and cost-effective IR communication system.

### BRIEF DESCRIPTION OF THE DRAWINGS

These and other features will become more apparent and the present invention will be better understood upon consideration of the following description and the accompanying drawings wherein:

FIG. 1 is a pictorial view of one embodiment of the IR communication system wherein crew members wearing IR headsets communicate directly with each other in a radio spectrum sensitive environment;

FIG. 2 is a front view of an IR headset in accordance with the present invention;

FIG. 3 is a block diagram of one embodiment of an IR transmitter;

FIG. 4 is a block diagram of one embodiment of an IR receiver;

FIG. 5 is an electrical schematic of one embodiment of an IR transmitter;

FIG. 6 is an electrical schematic of one embodiment of an IR receiver;

FIG. 7 is a graphic depiction of the IR emission beam generated by an IR transmitter;

FIG. 8 is a graphic depiction of the IR detection envelope of an IR receiver; and

FIG. 9 is a perspective view of an alternate embodiment in the form of a mobile IR module that is mountable in an aircraft or other vehicle cabin and is connectable to the communication system.

### DETAILED DESCRIPTION OF EMBODIMENTS OF THE INVENTION

The embodiments of the invention described herein are not intended to be exhaustive or to limit the invention to the precise forms disclosed. Rather, the embodiments selected for description have been chosen to enable one skilled in the art to practice the invention.

The present invention is directed to an infrared (hereinafter referred to as IR) communication system for full-duplex communication between mobile IR devices such as headsets or a headset and a mobile module connectable to an aircraft or other vehicle communication system. The communication system is especially useful in applications demanding portability and requiring wireless communication in a radio spectrum sensitive environment.

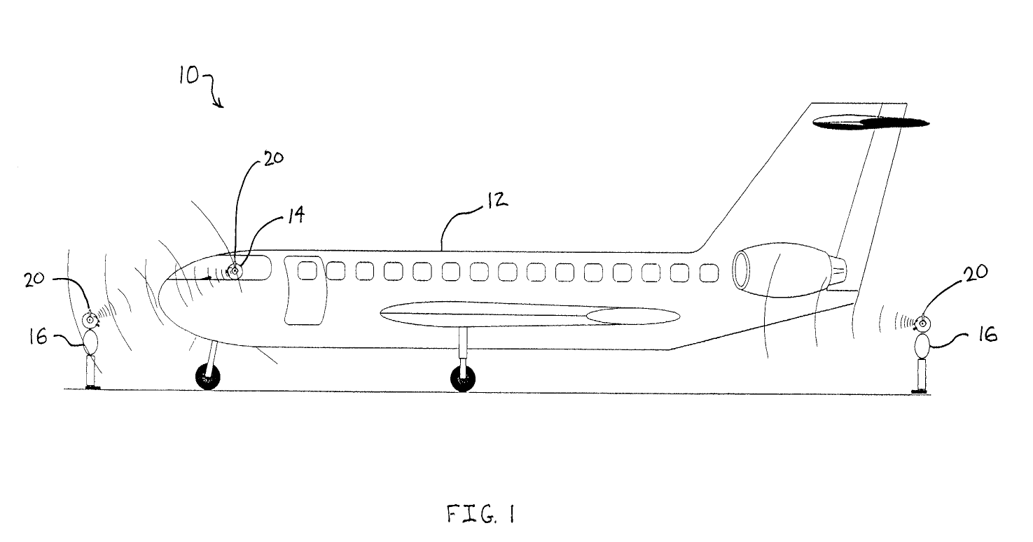

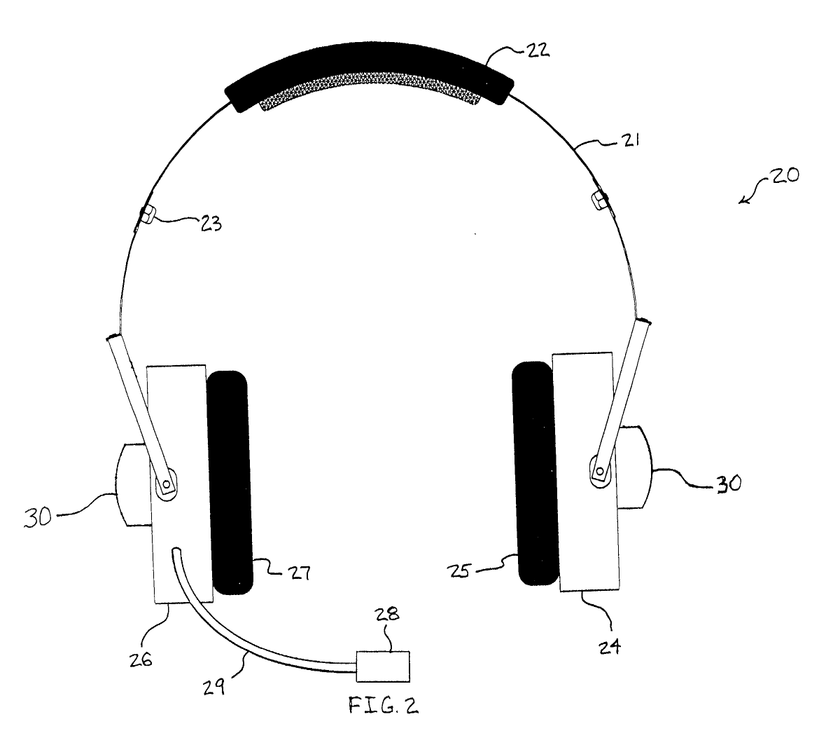

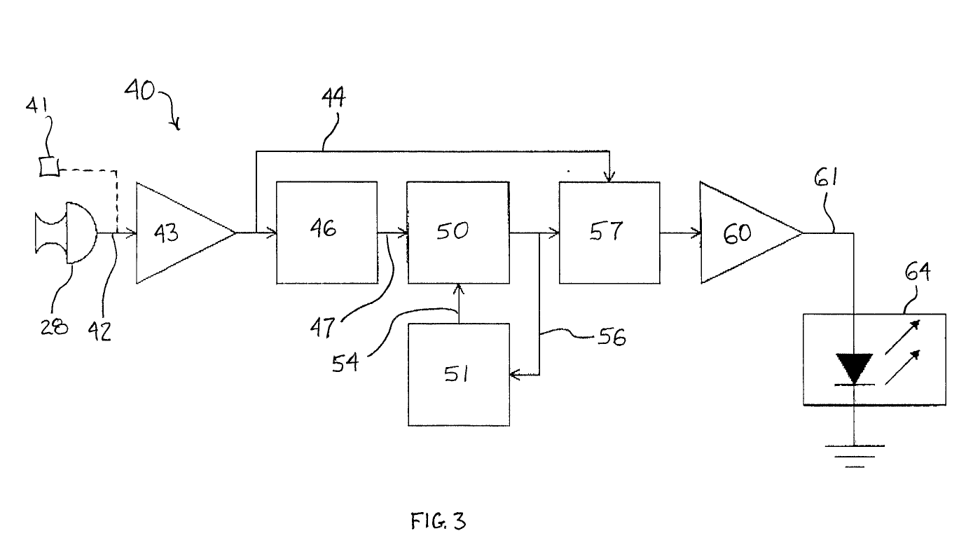

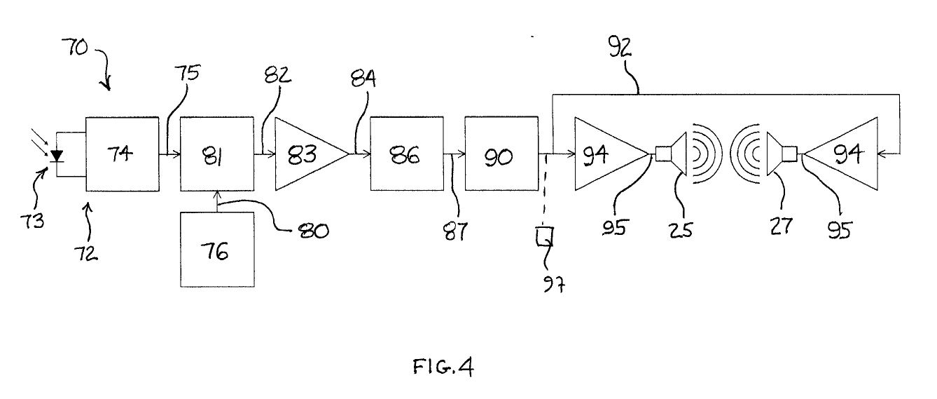

Referring to FIG. 1, a first embodiment of the IR communication system 10 is shown in which aircrew 14 and ground crew 16 associated with an aircraft 12 are equipped with headsets 20. Each IR headset 20 is shown in FIG. 2, as having the typical components of a communication headset: a headband 21; comfort padding 22 located along the headband; a fit adjustment device 23; left and right earphone housings 24, 26; a left and right earphone 25, 27; and a microphone 28 and microphone boom 29. The headset 20 can be powered by a battery, a vehicle power source, or other power source. As shown in FIG. 2, an emitter/detector array 30 is located on each housing 24, 26. The left and right housings 24, 26 contain a transmitter circuit 40 (FIG. 3) and a receiver circuit 70 (FIG. 4) which allow full-duplex communication between the various users 14, 16. With respect now to FIG. 3, the transmitter circuit 40 will be described in greater detail.

The transmitter circuit 40 receives an audio input signal 42 from a microphone 28 or an input connector 41 and inputs it to pre-amp 43. Pre-amp 43 receives the audio signal 42 and outputs a pre-amp audio signal 44 to a transmitter voice activated switch 57 and a pre-emphasis circuit 46. The pre-emphasis circuit 46 improves the communication system's signal-to-noise ratio. The emphasized audio signal 47 is then frequency modulated by a modulator 50 about a carrier frequency 54 produced by a transmitter frequency synthesizer 51. The transmitter FM signal 56 is then switched by the transmitter voice activated switch 57 for delivery to a power amplifier 60. The power amp 60 produces an LED driver signal 61 used to drive the IR LED emitter 64.

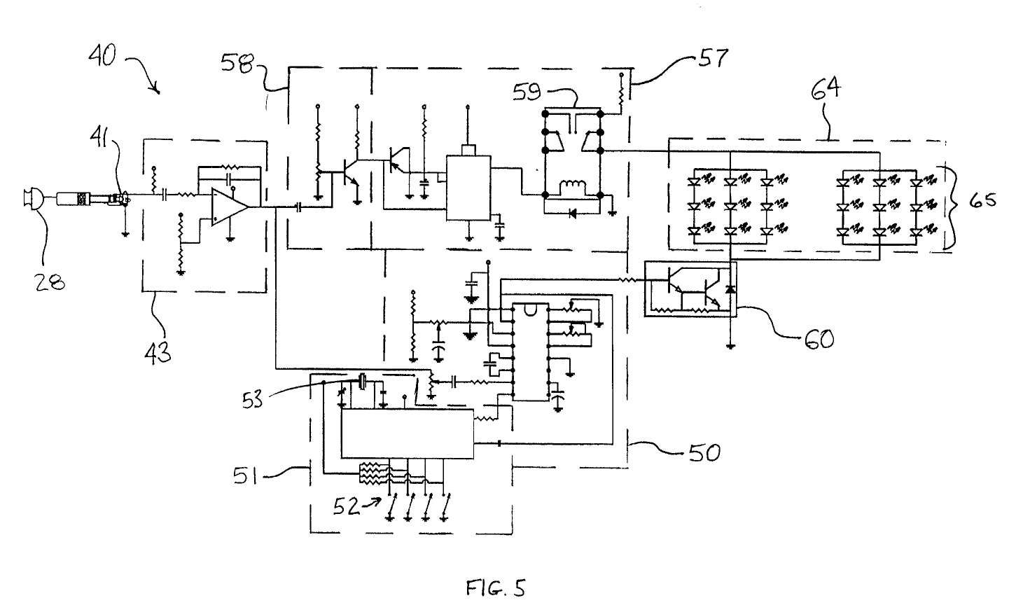

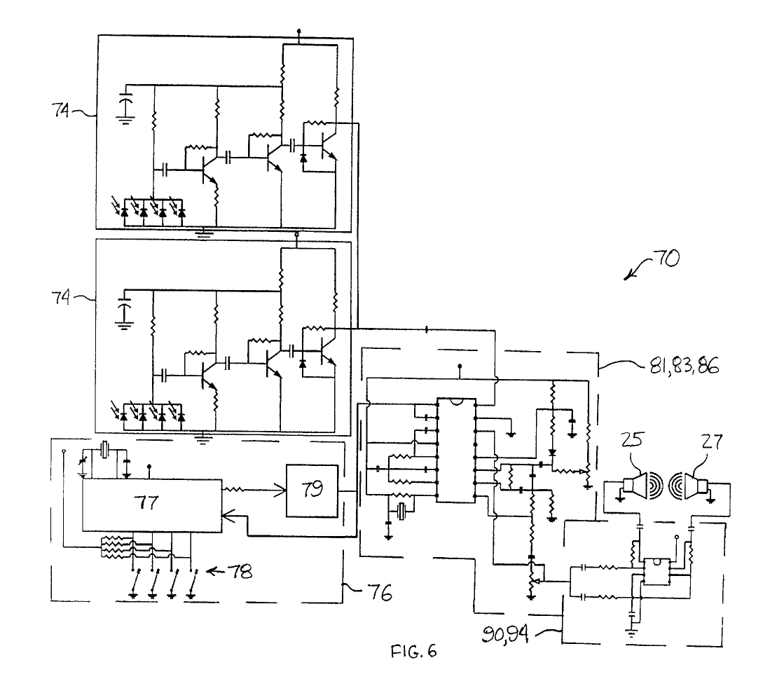

As shown in further detail in FIG. 5, the preferred embodiment of the transmitter circuit 40 includes a number of standard electrical components. The transmitter voice activated switch 57 may include a threshold adjustment circuit 58 and a switching relay 59. In addition, the circuit can be arranged as shown in FIG. 6 where the power amplifier 60 acts as a drain or sink gate to power the IR LED emitter 64 and the switching relay 59 switches the source voltage on when the audio signal 44 threshold exceeds that set by the threshold adjustment circuit 58. Though various network configurations could be used for the IR LED emitter 64, the embodiment of the circuit shown in FIG. 5 has eighteen LEDs 65 in a series and parallel network. Also as shown in FIG. 5, the transmitter frequency synthesizer 51 is crystal stabilized by transmitter crystal 53 and has a transmitter frequency select switch 52 for setting the carrier frequency. The frequency select switch 52 shown in FIG. 5 is capable of selecting a carrier frequency from a set of sixteen frequencies. The carrier frequencies are preferably in the range of 50-250 kHz.

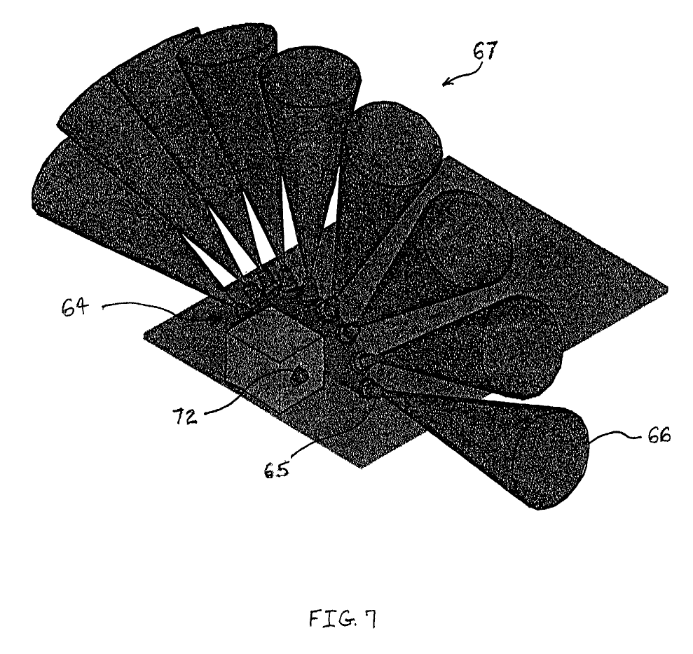

Referring now to FIG. 7, the transmitter circuit 40 includes a plurality of IR LEDs 65. The LEDs 65 are mounted so that their individual emission lobes 66 are adjacent to each other and form a wide emission beam 67 in azimuth. In the preferred embodiment, there are eighteen LEDs 65 each having an emission lobe with a half-power point of at least 15°. The LEDs 65 are located on an arc in the horizontal plane so that the emission beam 67 extends through approximately 360° in azimuth and 15° in elevation. The LEDs preferably emit the IR signal 68 at a wavelength of 940 nm. Each transmitter 40 operates on a carrier frequency that is field selectable. The transmitter 40 of each IR device 20, 130 are selectable to a different carrier frequency so that the communication system 10 can support full-duplex communication. With the transmitter circuit 40 described as mentioned above, the receiver circuit 70 will be described in greater detail.

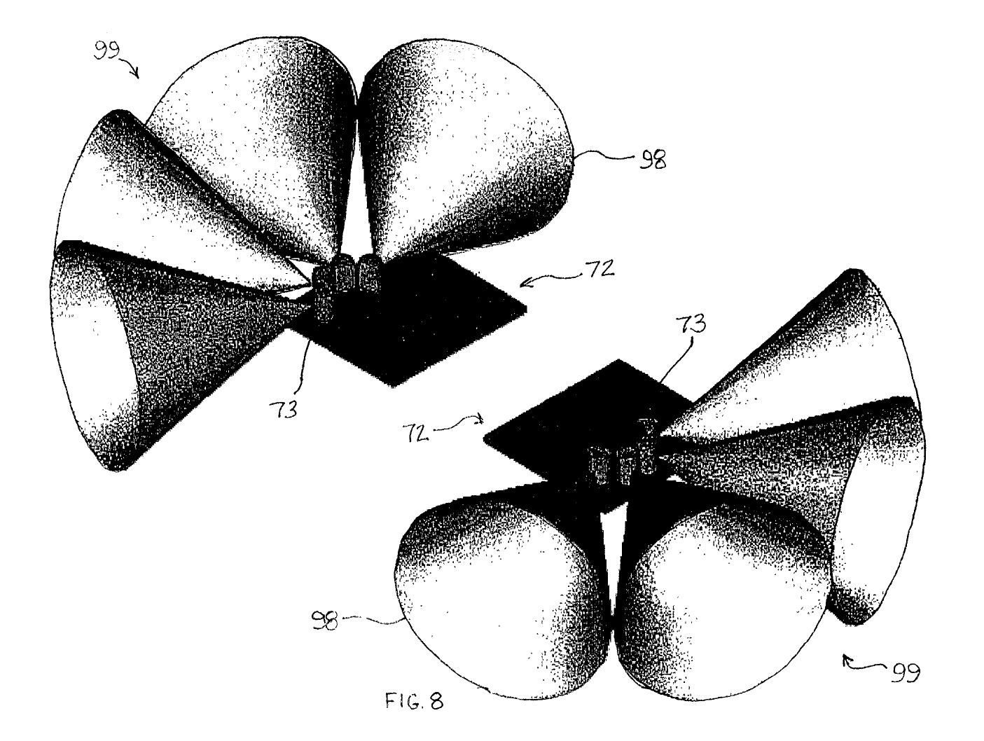

Each receiver circuit 70 as shown in FIGS. 4 and 6 receives the IR signal 68 at an IR PIN detector 72 and produces an audio signal 92 that is amplified for delivery to a headset earphone 25, 27. As shown in FIG. 8, individual PIN devices 73 are arranged so that their respective detection lobes 98 form a wide detection envelope 99 in a horizontal plane. In the preferred embodiment, the PIN devices 73 are sensitive to 940 nm IR and have a detection lobe 98 with a half-power point of at least 45°. Two sets of four PIN devices 73 each form a detection envelope 99 of approximately 360° in azimuth and at least 45° in elevation. With the transmitters and receivers as described above, the operation of the unit will now be described in greater detail. Each IR headset further includes a receiver circuit 70 having an IR detector 72 with a detection envelope 99 (FIG. 8) extending approximately 360° in azimuth. With the transmitter 40 and receiver 70 circuits so described, the operation of the assembly will now be described.

Referring again to FIGS. 5 and 6, the PIN devices 73 are connected to a plurality of PIN amplifiers 74 to produce an amplified IR signal 75. A local oscillator 76 produces a local oscillator frequency 80 that is combined by mixer 81 with the amplified IR signal 75 to produce an IF FM signal 82. An IF amplifier 83 produces an amplified IF FM signal 84 for delivery to an FM detector 86 which produces a demodulated audio signal 87. A de-emphasis circuit 90 then produces the audio signal 92 that is delivered to an output connector 97 for delivery to an aircraft communication system, or to audio amplifiers 94 to drive a left and right earphone 25, 27. The receiver circuit 70 shown in further detail in one embodiment in FIG. 6 has two PIN amplifiers 74 each having four PIN devices 73 connected in parallel. The amplified IR signal 75 is then mixed, amplified and demodulated by receiver circuit 81, 83, 86. The local oscillator 76 can include a voltage controlled oscillator 79 that is driven by a crystal stabilized frequency synthesizer 77 having a frequency selected by frequency select switch 78. As with the transmitter frequency select switch 52, the receiver frequency select switch 78 can select a frequency from a set that may include at least sixteen channels.

The headset microphone 28 is electrically connected to the transmitter circuit 40 so that voice input produces an IR emission beam 67 as shown in FIG. 7 from the IR emitter 64. Another IR headset 20 of the IR communication system 10 is capable of detecting the IR emission beam 67 within a detection envelope 99 as shown in FIG. 8. For example, the PIN/LED array 30 includes an IR PIN detector 72 electrically connected to a receiver circuit 70 that provides an amplified audio signal to the left and right earphone 25, 27 in response to the detected IR emission beam 67.

The frequency channel scheme can utilize a different carrier frequency for the transmitter 40 and receiver 70 of a single IR device 20, so that full-duplex communication is supported. For example, in a system having a first IR headset 20A and a second IR headset 20B, the transmitter 40 of the first headset 20A will operate on the same first carrier frequency as the receiver circuit 70 of the second headset 20B. Conversely, the transmitter circuit 40B of the second headset 20B will operate on the same second carrier frequency as the receiver circuit 20A of the first headset 20A. Thus, the two carrier frequencies support full-duplex communications between the first and second headset 20A, 20B.

The receiver circuit 70 may also include a squelch adjust, a volume control, a mute select, and other typical receiver circuits and controls. Similarly, the transmitter circuit 40 may include an audio input level adjust and other standard transmitter circuits and controls. The IR communication system 10 is also expandable beyond two IR devices 20. Additional IR devices 20 can operate on the same first and second carrier frequencies as the other devices, or by selecting other transmit and receive channels. A pairing of IR devices 20 can be isolated from other pairings by selecting different carrier frequencies for each device pair.

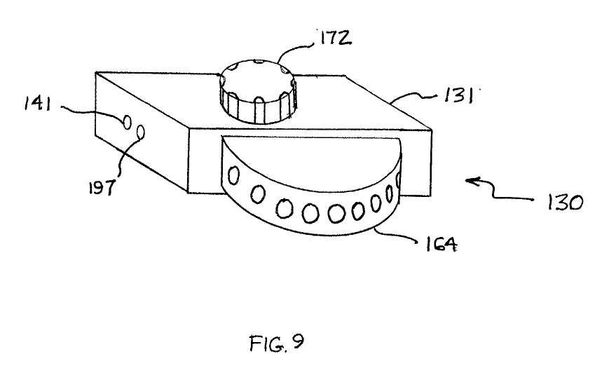

In another embodiment of the current invention, an IR device of the communication system 110 may be in the form of an IR transmitter/receiver module 130 as shown in FIG. 9. The headset 20 as shown in FIG. 2 may be used with a mobile IR module 130 shown in FIG. 9 for wireless IR communication between an aircrew 14 wearing a headset 20 and the communication system of the aircraft 12. The module 130 has a housing 131 containing a transmitter circuit 140 and a receiver circuit 170 that may be the same as the circuits 40, 70 used in the headset 20. The transmitter circuit 140 similarly includes an IR LED emitter 164, and the receiver circuit 170 similarly includes an IR PIN detector 172. Rather than including a microphone 28 and left and right earphones 25, 27, the IR transmitter receiver module 130 includes an input connector 141 and an output connector 197 for respectively receiving an audio input from an aircraft or other vehicle communication system and for delivering an audio output to the communication system. Thus, in one application of the current invention, an aircrew or passenger 14 of an aircraft 12 can communicate with the aircraft communication system by wearing a headset 20 that is in full-duplex communication with an IR module 30 that is electrically connected to the aircraft communication system. Additional aircrew or passengers 14 may likewise wear a headset 20 for communicating through the same IR module 130, or each additional air crew or passenger 14 may have their own IR module 130 that is electrically connected to the aircraft communication system, thereby allowing the aircraft communication system to handle mixing and priority of voice communications from the various air crew or passengers 14.

The IR transmitter and receiver module 130 is positioned in the cockpit so that it has line of sight with the emission beam 67 of the headset(s) 20. Also, if it is desirable to communicate with ground crew 16, the IR module 130 is positioned to provide line of sight with the ground crew 16 emission beam 67. One practical location in an aircraft is on top of the instrument panel sun shield. Although line of sight reception of an emission beam 67 is preferable, the receivers 30, 130 may also detect reflected emission beams.

Although the present invention has been shown and described in detail, the same is to be taken by way of example only and not by way of limitation. Numerous changes can be made to the embodiments described above without departing from the scope of the invention. This application is therefore intended to cover any variations, uses, or adaptations of the invention using its general principles. Further, this application is intended to cover such departures from the present disclosure as come within known or customary practice in the art to which this invention pertains.

What is claimed is:

1. A mobile full-duplex IR communication system for communicating between at least a first headset microphone and earphone and a vehicle communication system, comprising:
a first transmitter means electrically connected to the first headset microphone and including a first plurality of IR emitters;
a first receiver means electrically connected to the first headset earphone and including a first plurality of IR detectors;
a first IR module mountable on a portion of a cabin of the vehicle and including a second transmitter means having a second plurality of IR emitters and a second receiver means having a second plurality of IR detectors; and
said second transmitter means and said second receiver means being electrically connectable to the vehicle communication system.

2. The mobile full-duplex IR communication system of claim 1, wherein:
the vehicle is an aircraft.

3. The mobile full-duplex IR communication system of claim 1, wherein:
the vehicle communication system includes a radio.

4. The mobile full-duplex IR communication system of claim 1, wherein:
the vehicle communication system includes an intercom.

5. The mobile full-duplex IR communication system of claim 1, wherein:
said IR emitters comprise IR lasers.

6. The mobile full-duplex IR communication system of claim 1, wherein:
said IR emitters comprise IR LEDs suitable for use in direct sunlight.

7. The mobile full-duplex IR communication system of claim 6, wherein:
said IR detectors comprise IR PIN devices suitable for use in direct sunlight.

8. The mobile full-duplex IR communication system of claim 7, wherein:
said IR receiver means comprises an IR detection envelope of approximately 360° in azimuth and at least 45° in elevation, said detection envelope comprising adjacent detection fields of view extending from each said IR PIN devices; and
said IR transmitter means further comprises an IR transmission beam of approximately 360° in azimuth and at least 15° in elevation, said transmission beam comprising adjacent transmission lobes extending from each said IR LED.

9. The mobile full-duplex IR communication system of claim 7, wherein:
said first IR transmitter means and said second IR receiver means are each settable to at least a first carrier frequency; and
said second IR transmitter means and said first IR receiver means each settable to at least a second carrier frequency.

10. The mobile full-duplex IR communication system of claim 9, wherein:
said first and second carrier frequencies are in the range of 50-250 KHz.

11. The mobile full-duplex IR communication system of claim 10, comprising:
a second headset microphone;
a second headset earphone;
a third transmitter means electrically connected to said second headset microphone and including a third plurality of IR emitters; and
a third receiver means electrically connected to said second headset earphone and including a third plurality of IR detectors.

12. The mobile full-duplex IR communication system of claim 11, wherein:
said third transmitter means is settable to at least said second carrier frequency; and
said third receiver means is settable to at least said first carrier frequency.

13. The mobile full-duplex IR communication system of claim 11, further comprising:
a second mobile IR module mountable on another portion of said cabin of the vehicle including a fourth transmitter means having a fourth plurality of IR emitters and a fourth receiver means having a fourth plurality of IR detectors;
said fourth transmitter means and said fourth receiver means being electrically connectable to the vehicle communication system;
said third transmitter means and fourth receiver means settable to at least a third carrier frequency; and
said third receiver means and said fourth transmitter means settable to at least a fourth carrier frequency.

14. The mobile full-duplex IR communication system of claim 1, wherein:
said first headset further comprises hearing protection.

15. The mobile full-duplex IR communication system of claim 14, further comprising
a left and right housing of said first headset containing said first transmitter means, said first receiver means, and a battery.

16. The mobile full-duplex IR communication system of claim 1, wherein:
said IR module further comprises a battery.

17. The mobile full-duplex IR communication system of claim 1, wherein:
said IR module is powered by an electric system of the vehicle.

18. A mobile full-duplex IR communication system for communicating between a first headset microphone and earphone and at least a second headset microphone and earphone, comprising:
a first FM transmitter means electrically connected to the first headset microphone and including a first plurality of IR emitters;
a first FM receiver means electrically connected to the first headset earphone and including a first plurality of IR detectors;
a second FM transmitter means electrically connected to the second headset microphone and including a second plurality of IR emitters; and
a second FM receiver means electrically connected to the second headset earphone and including a second plurality of IR detectors.

19. The mobile full-duplex IR communication system of claim 18, wherein:
said first FM transmitter means and said second FM receiver means are operable for at least a first carrier frequency; and
said second FM transmitter means and said first FM receiver means are operable for at least a second carrier frequency.

20. The mobile full-duplex IR communication system of claim 19, wherein:
said first and second carrier frequencies are in the range of 50-250 KHz.

21. The mobile full-duplex IR communication system of claim 19, wherein:
said first and second FM transmitter means and said first and second FM receiver means are each settable to any one of at least sixteen carrier frequencies in the range of 50-250 KHz.

22. The mobile full-duplex IR communication system of claim 21, wherein:
said IR emitters comprise IR lasers.

23. The mobile full-duplex IR communication system of claim 21, wherein:
said IR emitters comprise IR LEDs suitable for use in direct sunlight; and
said IR detectors comprise IR PIN devices suitable for use in direct sunlight.

24. The mobile full-duplex IR communication system of claim 23, wherein:
said first and second plurality of IR emitters are each arranged to produce an IR transmission beam of approximately 360° in azimuth and at least 7½° elevation above the horizontal plane to 7½° elevation below the horizontal plane; and
said first and second plurality of IR detectors are each arranged to form an IR detection envelope of approximately 360° in azimuth and at least 45° in elevation.

25. The mobile full-duplex IR communication system of claim 24, wherein:
said IR emitters operate at a wavelength of about 940 nm.

26. The mobile full-duplex IR communication system of claim 24, wherein:
said first and second headset further comprise hearing protection.

27. The mobile full-duplex IR communication system of claim 26, further comprising:
a left and right housing for each of said headsets, said left and right housings containing the respective transmitter means, receiver means, and a battery.

28. The mobile full-duplex IR communication system of claim 27, wherein:
said transmitter means further comprise a voice-activated switching means.

29. A mobile IR communication device for communicating between an IR headset and an aircraft communication system, comprising:
a transmitter means having a plurality of IR emitters;
a receiver means having a plurality of IR detectors;
said transmitter means and said receiver means housed by a mobile module mountable on a portion of a cabin of the aircraft and electrically connectable to the aircraft communication system;
said receiver means operable to receive a first IR transmission beam from the IR headset at a first carrier frequency; and
said transmitter means operable to transmit a second IR transmission beam detectable by the IR headset at a second carrier frequency.

30. A mobile IR communication system for communicating between an IR transmitter means and an IR receiver means, comprising:
a plurality of IR emitters electrically connected to the IR transmitter means and producing an IR transmission beam of approximately 360° in azimuth and at least 7½° elevation above the horizontal plane to at least 7½° elevation below the horizontal plane;
a plurality of IR detectors electrically connected to the IR receiver means and having an IR detection envelope of approximately 360° in azimuth and at least 45° in elevation;
a first mobile unit housing the IR transmitter means and said plurality of IR emitters; and
a second mobile unit housing the IR receiver means and said plurality of IR detectors.

31. The mobile IR communication system of claim 30, wherein:
said IR emitters comprise IR LEDs having a wavelength of about 940 nm and a transmission lobe extending to a half power point of at least ±7½°.

32. The mobile IR communication system of claim 31, wherein:
said IR detectors comprise IR PIN devices having a detection field of view extending to a half power point of at least 22½°.

33. A mobile IR communication system for voice communication between a first mobile unit and a second mobile unit, comprising:
an FM IR transmitter means having a plurality of IR emitters and housed by the first mobile unit;
an FM IR receiver means having a plurality of IR detectors and housed by the second mobile unit;
a set of carrier frequencies in the range of 50-250 KHz;
said FM IR transmitter means and said FM IR receiver means field settable to any member of said set of carrier frequencies; and
whereby the first mobile unit is capable of transmitting an IR transmission beam at said any member of said set of carrier frequencies and the second mobile unit is capable of receiving said IR transmission beam.

34. The mobile IR communication system of claim 33, wherein:
said set of carrier frequencies comprises at least 16 channels.

35. A transmitter circuit for receiving an audio input signal and transmitting an FM IR transmission beam, comprising:
a pre-amplifier comprising an op-amp;
a pre-emphasis circuit coupled to said pre-amplifier;
a crystal-stabilized frequency synthesizer having a frequency select switch;
a modulator coupled to said pre-emphasis circuit and said frequency synthesizer;
a threshold adjustable voice activated switch coupled to said pre-amplifier;
a plurality of parallel coupled strings of series coupled IR LED emitters having the anode end of said strings coupled to said voice activated switch and the cathode end of said strings coupled to the drain of a power amp; and
the gate of said power amp coupled to said modulator.

36. A receiver circuit for receiving an FM IR transmission beam and generating an audio signal, comprising:
a first plurality of parallel coupled PIN devices;
a first plurality of PIN amplifiers coupled to said first plurality of PIN devices;
a second plurality of parallel coupled PIN devices;
a second plurality of PIN amplifiers coupled to said second plurality of PIN devices;
a mixer coupled to said first and second plurality of PIN amplifiers and a local oscillator;
said local oscillator comprising a voltage controlled oscillator coupled to a crystal stabilized frequency stabilizer having a frequency select switch;
an IF amp coupled to said mixer;
an FM detector coupled to said IF amp;
a de-emphasis circuit coupled to said FM detector; and
an audio amplifier coupled to said de-emphasis circuit.

37. A method of IR communication between at least two users comprising the steps of:
equipping a first user with a headset microphone and an IR transmitter;
equipping a second user with a headset earphone and an IR receiver;
directing a first user's IR transmission beam toward the second user;
speaking into the first user's headset microphone to create a first audio signal;
generating a first frequency modulated signal in response to said first audio signal;
radiating said first IR transmission beam in response to said first FM signal when said first audio signal exceeds a set threshold;
detecting said first IR transmission beam with said IR receiver;
generating a second FM signal in response to said IR transmission beam;
generating a second audio signal by demodulating said second FM signal;
amplifying said second audio signal; and
driving said headset earphone in response to said second audio signal.

38. A method of using an IR headset with a vehicle audio panel, comprising:
equipping an operator with a headset microphone, at least one headset earphone, a first IR transmitter, and a first IR receiver;
connecting a second IR transmitter to an output channel of the vehicle audio panel and a second IR receiver to an input channel of the vehicle audio panel;
generating a first audio signal in response to speech into said microphone;
radiating a first IR beam from said first IR transmitter in response to said first audio signal;
detecting said first IR beam using said second IR receiver;
generating a second audio signal for connection to said input channel and in response to said first IR beam;
radiating a second IR beam from said second IR transmitter in response to a third audio signal from said output channel;
detecting said second IR beam using said first IR receiver; and
generating an amplified fourth audio signal for connection to said earphone and in response to said second IR beam.
